(19) United States
(12) Patent Application Publication
(10) Pub. No.: US 2024/0067387 A1
(43) Pub. Date: Feb. 29, 2024

(54) TRAY-BASED STERILE PACKAGING OF PHARMACEUTICAL VIALS AND VIAL CLOSURES

(71) Applicant: West Pharmaceutical Services, Inc., Exton, PA (US)

(72) Inventors: Oliver OTTE, Aachen (DE); Michael BIEN, Aachen (DE); Samuel SKRAN, King of Prussia, PA (US); Matthew SWEENEY, West Chester, PA (US)

(21) Appl. No.: 18/270,198

(22) PCT Filed: Dec. 28, 2021
(86) PCT No.: PCT/US2021/065324

§ 371 Date: Jun. 28, 2023

Related U.S. Application Data
(60) Provisional application No. 63/131,151, filed on Dec. 28, 2020.

(51) Int. Cl. B65D 1/36; B01L 9/00; B65D 1/46; B65D 43/02; B65D 51/26; B65D 77/04

(52) U.S. Cl. CPC B65D 1/36; B01L 9/56; B65D 1/46; B65D 43/0202; B65D 51/26; B65D 77/04; B01L 2200/021; B01L 2300/0609; B01L 2300/0848; B65D 2543/00194

(57) ABSTRACT

Small batch packaging for vial seals and vial stoppers is provided. The packaging includes a vial tray having a plurality of individual spaced-apart vial receptacles for receiving respective vials. The packaging also includes a vial seal tray having a plurality of individual spaced-apart seal receptacles for receiving respective vial seals. The packaging further includes a stopper tray having a plurality of individual spaced-apart stopper receptacles for receiving respective vial seals. A seal channel may extend through the plurality of individually spaced-apart seal receptacles to form a clearance for facilitating grasping of each vial seal. Similarly, a stopper channel may extend through the plurality of individually spaced-apart stopper receptacles to form a clearance for facilitating grasping of each vial stopper.

### CROSS REFERENCE TO RELATED APPLICATIONS

This application claims the benefit of U.S. Provisional Patent App. No. 63/131,151, filed Dec. 28, 2020, the disclosure of which is hereby incorporated by reference herein.

### FIELD OF THE INVENTION

The present disclosure generally relates to trays for vials and vial closures, and more particularly, to sterile trays for pharmaceutical vial stoppers and vial seals.

### BACKGROUND

Research and production of novel biological medicines, such as various gene therapies, requires manual or semi-automated filling of container closure systems in small quantities. During this process, the steps of filling medication containers, such as glass or polymeric vials, closing the vials with elastomeric stoppers, and capping the vials with crimped aluminum seals, are typically performed manually for small batch quantities using compact workspaces, such as small biosafety cabinets or laboratory desks having a hood. However, stoppers and seals for pharmaceutical vials are typically manufactured and shipped in large batch quantities as bulk packaging, such as in sterile bags. For instance, cell and gene therapy manufacturers typically use pharmaceutical closures available only in larger quantity bulk packs that were developed for fill and finish processes of large batches with automated filling machines. This can cause a complex and difficult process for unpacking of the closure bulk packs, as well as a complex and difficult aseptic transfer process of the closures onto corresponding vials when performed in a small biosafety cabinet. As a result, there is a substantial risk for microbial and particulate contamination to the assembled and filled pharmaceutical vials.

Moreover, such bulk packaging requires the user to unpack a small portion of the vial closure components from the bulk package, and then place them into a biosafety cabinet before use. This unpacking process often results in the user either dropping the closures onto a laboratory desk surface or refilling the contents of the bulk package into a separate container, such as a glass dish, under aseptic conditions. Such a process is also cumbersome since larger bulk pack formats are difficult to handle in the compact laboratory or biosafety cabinet setting. Furthermore, retrieving an individual closure member from a bulk pack requires multiple steps, which frequently leads to numerous closures being touched and moved. As a result, this process poses a substantial risk of breaching the intended sterility of the closures.

It is therefore a goal to allow a user to easily be able to access both vial seals and vial stoppers from corresponding small batch trays while working at a compact work space. Such an arrangement would be much easier than having to use conventional packaging methods for the seals and stoppers, which are bulk packaged in bags that the user first has to empty on the surface of the workspace and then spread out the individual closure members in order to pick out each one for placement on a vial. Such a conventional process is especially difficult to do with limited space in a biosafety cabinet or on a laboratory desk. Moreover, a substantial risk of contamination is present when a user has to reach into a bulk closure bag to grab one or more of the closure elements since there is a high risk of contaminating other components in the bag due to a breach of sterility therein.

Although conventional trays for the storage and stocking of medical or pharmaceutical preparations are typically used on a large scale, such trays are usually delivered to a pharmaceutical manufacturer or to a plant for further processing in a predetermined arrangement, such as while being held or accommodated in a supporting structure. However, such conventional trays are not well-suited for use in the laboratory or biosafety cabinet setting. Accordingly, there is a clear and substantial need for trays and associated kits that provide a novel small quantity presentation of sterile ready-to-use closure members, wherein the trays and kits are designed for easy handling and safe use in fill & finish processes carried out in a compact environment, including a laboratory desk or biosafety cabinet, such as those for small batch cell and gene therapy medications. Further, there is a need for trays and kits that are safer and easier to handle than conventional bulk packaging by allowing a user to touch one individual component stored in the tray at a time.

### SUMMARY

The foregoing needs are met, to a great extent, by the packaging trays of the present disclosure, including a vial seal tray comprising a body having a top surface defining a receptacle array, the receptacle array comprising a plurality of receptacle rows, each of the plurality of receptacle rows comprising a plurality of individual spaced-apart receptacles configured to releasably secure a respective vial seal; a connection web disposed on the top surface of the vial seal tray and interconnecting the plurality of individual receptacles, each receptacle defining a hollow cavity extending downwardly from the top surface of the vial seal tray and forming a closed lower end, the hollow cavity configured to receive a portion of the vial seal; a region protruding upwardly from a central portion of the closed lower end of each receptacle for supporting the vial seal; and a channel extending through the plurality of individually spaced-apart receptacles disposed in each respective receptacle row, the channel forming a clearance on opposing sides of each receptacle for facilitating grasping of the vial seal held in the corresponding receptacle.

According to another aspect of the present disclosure, the plurality of receptacle rows are arranged parallel to each other and laterally offset from one another, such that the position of each receptacle in adjacent receptacle rows is correspondingly offset from one another.

According to another aspect of the present disclosure, each receptacle has a generally cylindrical shape.

According to another aspect of the present disclosure, the vial seal tray includes a base defining a flange protruding outwardly along a periphery of the vial seal tray.

According to another aspect of the present disclosure, a tray wall extends between the top surface and the base along the periphery of the vial seal tray.

According to another aspect of the present disclosure, the tray wall includes a notch configured to facilitate stacking with another vial seal tray.

According to another aspect of the present disclosure, the top surface of the vial seal tray includes a chamfered edge along its perimeter to facilitate stacking with another vial seal tray.

According to another aspect of the present disclosure, wherein the region includes a tip portion having a hemispherical shape.

According to another aspect of the present disclosure, a vial stopper tray comprises a body having a top surface defining a receptacle array, the receptacle array comprising a plurality of receptacle rows, each of the plurality of receptacle rows comprising a plurality of individual spaced-apart receptacles configured to releasably secure a respective vial stopper; a connection web disposed on the top surface of the vial stopper tray and interconnecting the plurality of individual receptacles, each receptacle defining a hollow cavity extending downwardly from the top surface of the vial stopper tray and forming a closed lower end, the hollow cavity configured to receive a portion of the vial stopper; a region protruding upwardly from a central portion of the closed lower end of each receptacle for supporting the vial stopper; and a channel extending through the plurality of individually spaced-apart receptacles disposed in each respective receptacle row, the channel forming a clearance on opposing sides of each receptacle for facilitating grasping of the vial stopper held in the corresponding receptacle.

According to another aspect of the present disclosure, each receptacle includes a bumper configured to releasably secure a portion of a corresponding vial stopper within the cavity.

According to another aspect of the present disclosure, the bumper extends radially inward from an inner wall of the receptacle, the bumper forming a constricted opening of the cavity.

According to another aspect of the present disclosure, the bumper is configured to snapingly engage a portion of the vial stopper.

According to another aspect of the present disclosure, the channel is further configured to permit steam to flow along the receptacle row for sterilizing each vial stopper disposed in the receptacle row.

According to another aspect of the present disclosure, a reinforcement rib may be disposed on the top surface of the stopper tray and extending perpendicularly to the channel for increasing stiffness of the top surface of the stopper tray.

According to another aspect of the present disclosure, each receptacle has a generally cylindrical shape.

According to another aspect of the present disclosure, the vial stopper tray includes a base defining a flange protruding outwardly along a periphery of the vial stopper tray.

According to another aspect of the present disclosure, a tray wall extends between the top surface and the base along the periphery of the vial stopper tray.

According to another aspect of the present disclosure, the tray wall includes a notch configured to facilitate stacking with another vial stopper tray.

According to another aspect of the present disclosure, the tray wall includes a pleat configured to provide increased stability to the stopper tray.

According to another aspect of the present disclosure, the vial stopper tray includes a chamfered edge along its perimeter to facilitate stacking with another vial stopper tray.

According to another aspect of the present disclosure, the region includes a tip portion having a hemispherical shape.

According to another aspect of the present disclosure, a stopper tray lid is configured to removably attach to the body of the vial stopper tray.

According to another aspect of the present disclosure, the stopper tray lid is configured to attach to the body of the vial stopper tray by a snap fit engagement.

According to another aspect of the present disclosure, the stopper tray lid includes a lid base having a side wall extending along a perimeter of the lid base, and a locking protrusion extending from a portion of the side wall for matingly engaging a portion of the body of the vial stopper tray.

According to another aspect of the present disclosure, the stopper tray lid includes a lid flange protruding outwardly along the perimeter of the stopper tray lid.

According to another aspect of the present disclosure, the stopper tray lid includes a bottom surface having a plurality of retention regions protruding therefrom, wherein each retention region is sized and shaped to fit within a corresponding receptacle of the vial stopper tray when the stopper tray lid is attached to the stopper tray.

According to another aspect of the present disclosure, the stopper tray lid includes a lid reinforcement rib protruding from a bottom surface of the lid base.

According to another aspect of the present disclosure, a kit comprises a vial tray comprising a tray base having a vial receptacle array, the vial receptacle array comprising a plurality of vial receptacle rows, each of the plurality of vial receptacle rows comprising a plurality of individual spaced-apart vial receptacles configured to receive a top portion of a respective vial; and a vial seal tray comprising a seal tray body having a top surface defining a seal receptacle array, the seal receptacle array comprising a plurality of seal receptacle rows, each of the plurality of seal receptacle rows comprising a plurality of individual spaced-apart seal receptacles configured to receive a respective vial seal, and a seal channel extending through the plurality of individually spaced-apart receptacles disposed in each respective seal receptacle row, the seal channel forming a clearance on opposing sides of each seal receptacle for facilitating grasping of the vial seal held in the corresponding receptacle; and a vial stopper tray comprising a stopper tray body having a top surface defining a stopper receptacle array, the stopper receptacle array comprising a plurality of stopper receptacle rows, each of the plurality of stopper receptacle rows comprising a plurality of individual spaced-apart stopper receptacles configured to receive a respective vial stopper, and a stopper channel extending through the plurality of individually spaced-apart stopper receptacles disposed in each respective stopper receptacle row, the stopper channel forming a clearance on opposing sides of each stopper receptacle for facilitating grasping of the vial stopper held in the corresponding receptacle.

According to another aspect of the present disclosure, the vial tray further comprises a vial tray lid including a plurality of recesses arranged to receive a bottom portion of a respective vial.

According to another aspect of the present disclosure, an outer periphery of the vial tray lid is shaped and dimensioned to fit within an open portion of the tray base for sealing each vial within the vial tray.

According to another aspect of the present disclosure, the vial tray lid is configured for snap fit engagement with the base of the vial tray.

According to another aspect of the present disclosure, a primary container is configured to receive the vial seal tray.

According to another aspect of the present disclosure, the primary container is a first sterile bag for providing a first sterile barrier.

According to another aspect of the present disclosure, a secondary container is configured to receive the vial seal tray and the primary container.

According to another aspect of the present disclosure, the secondary container is a second sterile bag. The secondary bag for the via seal trays may act as a second sterile barrier.

There has thus been outlined certain embodiments of the present disclosure in order that the detailed description thereof herein may be better understood, and in order that the present contribution to the art may be better appreciated. There are additional embodiments of the present disclosure that will be described below and which form the subject matter of the claims appended hereto.

In this respect, before explaining at least one aspect of the packaging trays in detail, it is to be understood that the packaging trays are not limited in their application to the details of construction and to the arrangements of the components set forth in the following description or illustrated in the drawings. The packaging trays are capable of aspects in addition to those described, and of being practiced and carried out in various ways.

### BRIEF DESCRIPTION OF THE DRAWINGS

In order that the present disclosure may be readily understood, aspects of the packaging trays are illustrated by way of examples in the accompanying drawings, in which like parts are referred to with like reference numerals throughout.

FIG. 1 illustrates a top perspective view of a vial seal tray according to the present disclosure.

FIG. 2 illustrates a bottom perspective view of the vial seal tray of FIG. 1.

FIG. 3 illustrates a top view of the vial seal tray of FIG. 1.

FIG. 4 illustrates a cross-sectional view of the vial seal tray taken along line IV-IV in FIG. 3.

FIG. 5 illustrates a top perspective view of a vial seal tray according to another implementation of the present disclosure.

FIG. 6 illustrates a bottom perspective view of the vial seal tray of FIG. 5.

FIG. 7 illustrates a top view of the vial seal tray of FIG. 5.

FIG. 8 illustrates a cross-sectional view of the vial seal tray taken along line VIII-VIII in FIG. 7.

FIG. 9 illustrates a top perspective view of a vial stopper tray according to the present disclosure.

FIG. 10 illustrates a bottom perspective view of the vial stopper tray of FIG. 9.

FIG. 11 illustrates a top view of the vial stopper tray of FIG. 9.

FIG. 12 illustrates a cross-sectional view of the vial stopper tray taken along line XII-XII in FIG. 11.

FIG. 13 illustrates a top perspective view of a vial stopper tray according to another implementation of the present disclosure.

FIG. 14 illustrates a bottom perspective view of the vial stopper tray of FIG. 13.

FIG. 15 illustrates a top view of the vial stopper tray of FIG. 13.

FIG. 16 illustrates a cross-sectional view of the vial stopper tray taken along line XVI-XVI in FIG. 15.

FIG. 17 illustrates a top perspective view of a vial stopper tray and stopper tray lid according to another implementation of the present disclosure.

FIG. 18 illustrates a top view of the vial stopper tray of FIG. 17.

FIG. 19 illustrates a cross-sectional view of the vial stopper tray taken along line XIX-XIX in FIG. 17.

FIG. 20 illustrates a bottom view of the vial stopper tray lid of FIG. 17.

FIG. 21 illustrates a front view of the vial stopper tray lid of FIG. 17.

FIG. 22 illustrates a top perspective view of a vial tray assembly according to the present disclosure.

FIG. 23 illustrates a top view of the vial tray of FIG. 22.

FIG. 24 illustrates a bottom perspective view of the vial tray of FIG. 22.

FIG. 25 illustrates a bottom view of a vial tray lid according to the present disclosure.

FIG. 26 illustrates a top perspective view of a vial tray assembly according to another implementation of the present disclosure.

FIG. 27 illustrates a top view of the vial tray of FIG. 26.

FIG. 28 illustrates a bottom perspective view of the vial tray of FIG. 26.

FIG. 29 illustrates a bottom perspective view of the vial tray lid of FIG. 26.

FIG. 30 illustrates a bottom view of the vial tray lid of FIG. 26.

### DETAILED DESCRIPTION

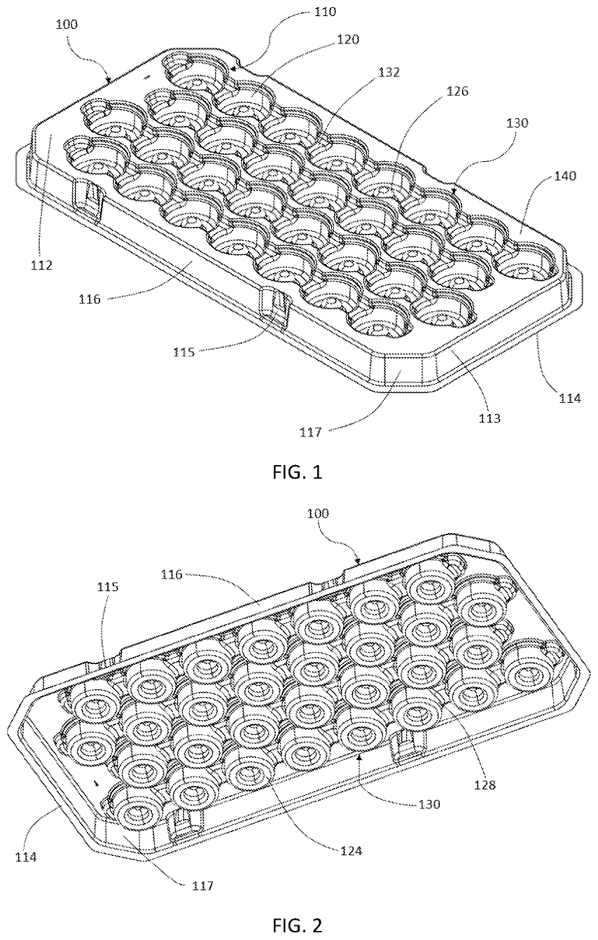

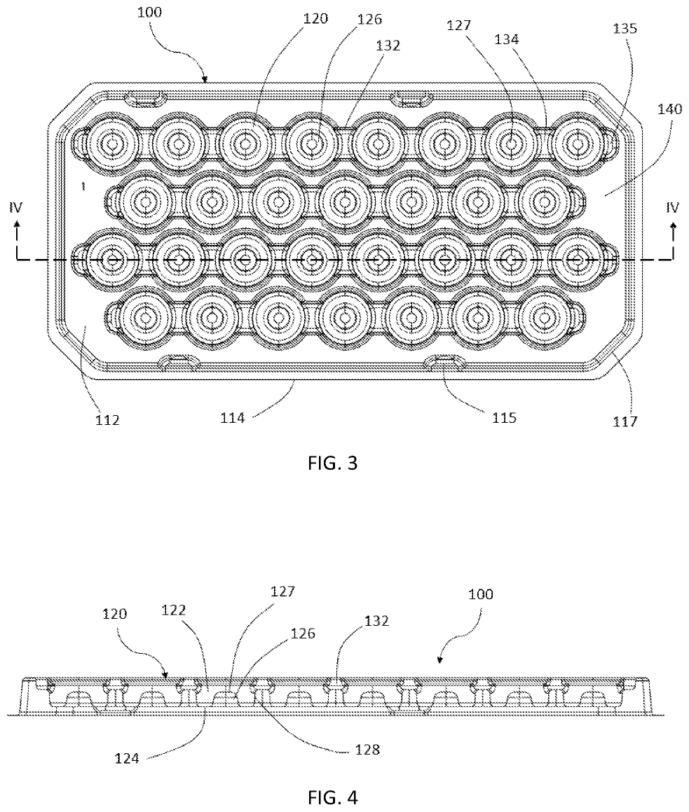

The present disclosure describes various configurations of sterile trays for closures, such as a stoppers and seals, for use with pharmaceutical vials. FIGS. 1-4 show a vial seal tray 100 comprising a receptacle array 110 having a plurality of individual receptacles 120, wherein each receptacle is configured to releasably receive and secure a vial seal. The vial seal tray 100 may be disposed within a container for protection of the vial seals, such as from contamination that could render each vial seal contained in the vial seal tray 100 unsuitable for subsequent assembly with a medicine vial. The container may be made from a material which is suitable for sterilization. In some instances, the container may include one or more sterile bags sized and shaped to accommodate the vial seal tray, wherein the bag is heat-sealed once the tray is contained therein. For instance, the vial seal tray 100 may be contained within a primary heat-sealed bag having a partial vacuum applied thereto to remove excess air. According to another aspect, the vial seal tray 100 within the primary bag may be further contained within a secondary heat-sealed bag.

The vial seal tray 100 comprises a box-like body having a top surface 112 which is substantially rectangular in shape, and a base 114 defining a stabilization flange protruding outwardly along a perimeter of the seal tray. A tray wall 116 extends between the top surface 112 and the base 114 along the perimeter of the seal tray. The top surface 112 of the seal tray may include a chamfered edge 113 along its perimeter to facilitate stacking with another vial seal tray. The tray wall 116 may include one or more cutouts or notches 115 to similarly facilitate stacking with another vial seal tray. Further, each corner 117 of the vial seal tray 100 may be cut off to facilitate insertion of the tray into a primary bag during the packing process. Further, the corners 117 may also help to facilitate stacking, as well as reduce the amount of raw material and associated costs required to manufacture the tray.

The receptacle array 110 includes a plurality of spaced apart rectilinear receptacle rows 130. The plurality of receptacle rows 130 are interconnected by a connection web 140 disposed on the top surface 112 of the vial seal tray 100. Each receptacle row 130 includes a plurality of individually spaced apart receptacles 120. Further, each receptacle row 130 defines a shallow channel 132 connecting each of the plurality of individually spaced apart receptacles 120. The shallow channel 132 defines a clearance space that allows for access of tweezers or a user's fingers to facilitate removal of the vial seals from the tray, as will be discussed further below. Further, some implementations may include pleats on the tray wall to increase stiffness of the tray.

Each receptacle 120 is configured to receive a portion of the vial seal and may be substantially cylindrical in shape. The plurality of rectilinear receptacle rows 130 are arranged parallel and laterally offset from one another so that the position of the corresponding receptacles 120 in adjacent receptacle rows is similarly offset from one another. This arrangement reduces the overall footprint of the tray by minimizing the amount of the connection web 140 disposed between the receptacle rows 130, thereby saving space on the top surface 112 of the vial seal tray. As a result, this arrangement allows a higher packing density of the vial seals. Thus, the alternating orientation of the receptacles 120 in adjacent receptacle rows 130 allows the receptacle array 110 to take up less space on the vial seal tray, and therefore allows the vial seal tray to be made smaller than conventional bulk trays.

In one implementation, the receptacle array 110 may include four spaced apart receptacle rows 130, with two of the receptacle rows having eight receptacles 120 and the other two receptacles having seven receptacles 120. Each receptacle 120 may be sized and shaped to accommodate a 20 mm vial seal. As such, the receptacle array 110 may be configured to releasably receive and secure up to thirty vial seals per tray. In other implementations, the receptacle array 110 may be configured to include more or less receptacle rows and associated receptacles. While the vial seal tray is shown as a box-like rectangular tray, in other implementations it may be made into alternative configurations suitable for its intended use, such as where the outer perimeter of the tray has a shape of a square, a circle, an oval, or various other shapes. In some implementations, the 20 mm vial seal tray may be manufactured using a female thermoform tool.

Each individual receptacle 120 includes a generally hollow cylindrical cavity 122 which extends downwardly from the connection web 140 at the top surface 112 of the tray to form a sidewall 128 bounded by a closed lower end 124. A partial circular rim below the upper surface 112 of the vial seal tray forms a resting support contact provided for the button of the vial seal to rest on. A narrow central protrusion or region 126 extends upwardly from a central region of the closed lower end 124. The region 126 includes a tip portion 127 configured to provide stiffness and stability to the cavity 122, In some aspects, the region 126 and tip portion 127 may be configured to support a vial seal when the vial seal is received within the receptacle in a generally vertical orientation. The tip portion 127 of the region 126 may have a hemispherical or dome shape, among other shapes. The shallow channel 132 connecting each receptacle 120 within a corresponding receptacle row 130 provides sufficient clearance or grip space 134 between each adjacent receptacle within the row, as well as sufficient clearance or grip space 135 at each end of the row next to a respective receptacle.

These grip spaces 134, 135 allow a user to manually grasp opposing sides of a vial seal disposed in a corresponding receptacle 120 in order to easily remove each individual vial seal from the tray by using either the user's fingers or a gripping tool. Further, these grip spaces 134, 135 also allow adjacent vial seals within a corresponding receptacle row to be spaced apart in order to prevent or minimize contamination between the vial seals. For instance, the grip spaces 134, 135 provide sufficient clearance that allows a user to remove a single vial seal from an individual receptacle 120 in the vial seal tray by gripping opposing sides of the vial seal by way of the respective grip spaces without touching or contaminating other vial seals disposed in the vial seal tray, such as a vial seal disposed in an adjacent receptacle 120 in the shared receptacle row 130. Such a tray configuration makes it easier for a user working at a small work space, such as a biosafety cabinet, to remove the individual vial seals from the tray. Directly adjacent receptacles 120 in each receptacle row 130 are spaced apart by the shallow channel 132, whereas adjacent receptacles 120 in adjacent receptacle rows 120 are separated by the connection web 140.

The vial seal tray 100 may be formed from one or more rigid or semi-rigid polymeric materials, including, but not limited to, polyethylene, polycarbonate, polypropylene and/or a composite combination of materials chosen to maintain the integrity of the stored vial seals. Additionally, a material, such as gamma stable polypropylene, which is stable following exposure to gamma radiation sterilization processes, may be used to make the vial seal tray.

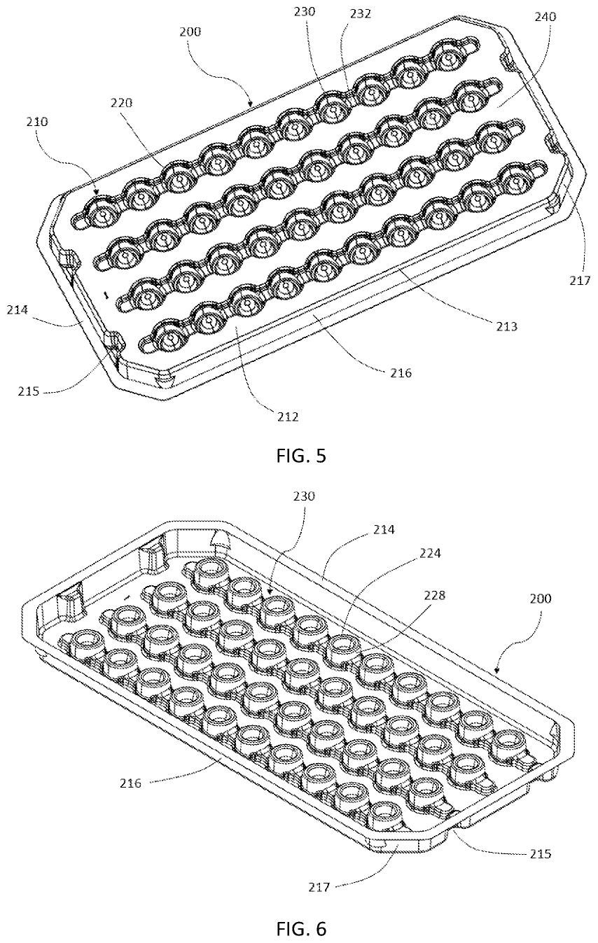

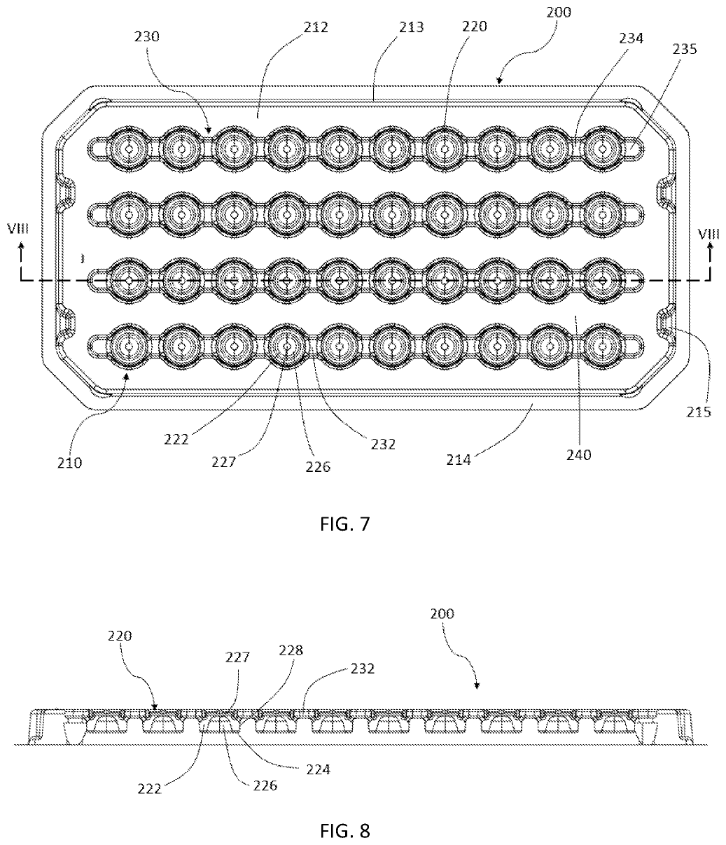

Another implementation of a vial seal tray 200 according to the present disclosure is illustrated in FIGS. 5-8. The vial seal tray 200 comprises a receptacle array 210 having a plurality of individual receptacles 220. Each individual receptacle is configured to releasably receive and secure a vial seal. The vial seal tray 200 may be disposed within a container for protecting the vial seals from contamination. For instance, the container may include one or more sterile bags sized and shaped to accommodate the vial seal tray, wherein the bag is heat-sealed once the tray is contained therein. The vial seal tray 200 may be contained within a heat-sealed primary bag having a partial vacuum applied thereto to remove excess air. According to another aspect, the vial seal tray 200 within the primary bag may further be contained in secondary heat-sealed bag.

The vial seal tray 200 comprises a box-like body having a top surface 212 which is substantially rectangular in shape, and a base 214 defining a stabilization flange protruding outwardly along a perimeter of the seal tray. A tray wall 216 extends between the top surface 212 and the base 214 along the perimeter of the seal tray. The top surface 212 of the seal tray may include a chamfered edge 213 along its perimeter to facilitate stacking with another vial seal tray. The tray wall 216 may include one or more cutouts or notches 215 to similarly facilitate stacking with another vial seal tray. Further, each corner 217 of the vial seal tray 200 may be cut off to facilitate insertion of the tray into a primary bag during the packing process. Further, the corners may also help to facilitate stacking, as well as reduce the amount of raw material and associated costs required to manufacture the tray.

The receptacle array 210 includes a plurality of spaced apart rectilinear receptacle rows 230. The plurality of receptacle rows 230 are interconnected by a connection web 240 disposed on the top surface 212 of the vial seal tray 200. Each receptacle row 230 includes a plurality of individually spaced apart receptacles 220. Further, each receptacle row 230 defines a shallow channel 232 connecting each of the plurality of individually spaced apart receptacles 220. The shallow channel 232 defines a clearance space that allows for access of tweezers or a user's fingers to facilitate removal of the vial seals from the tray, as will be discussed further below. Each receptacle 220 is configured to receive a portion of the vial seal and may be substantially cylindrical in shape. The plurality of rectilinear receptacle rows 230 are arranged parallel to and spaced apart from each other, whereby the connection web 240 on the top surface 212 interconnects the receptacle rows 230.

The receptacle array 210 may include four spaced apart receptacle rows 230, with each of the receptacle rows having ten receptacles 220. Each receptacle 220 may be sized and shaped to accommodate a 13 mm vial seal. As such, the receptacle array 210 may be configured to releasably receive and secure up to forty vial seals per tray. In other implementations, the receptacle array 210 may be configured to include more or less receptacle rows and associated receptacles. While the vial seal tray is shown as a box-like rectangular tray, in other implementations it may be made into alternative configurations suitable for its intended use, such as where the outer perimeter of the tray has a shape of a square, a circle, an oval, or various other shapes. In some implementations, the 13 mm vial seal tray may be manufactured using a male thermoform tool.

Each individual receptacle 220 includes a generally hollow cylindrical cavity 222 which extends downwardly from the connection web 240 at the top surface 212 of the tray to form a sidewall 228 bounded by a closed lower end 224. A partial circular rim below the upper surface 212 of the vial seal tray forms a resting support contact provided for the button of the vial seal to rest on. A narrow central protrusion or region 226 extends upwardly from a central region of the closed lower end 224. The region 226 includes a tip portion 227 configured to provide stiffness and stability to the cavity 222. In some aspects, the region 226 and tip portion 227 may be configured to support a vial seal when the vial seal is received within the receptacle in a generally vertical orientation. The tip portion 227 of the region 226 may have a hemispherical or dome shape, among other shapes. The shallow channel 232 connecting each receptacle 220 within a corresponding receptacle row 230 provides sufficient clearance or grip space 234 between each adjacent receptacle within the row, as well as sufficient clearance or grip space 235 at each end of the row next to a respective receptacle.

These grip spaces 234, 235 allow a user to manually grasp opposing sides of a vial seal disposed in a corresponding receptacle 220 in order to easily remove each individual vial seal from the tray by using either the user's fingers or a gripping tool. Further, these grip spaces 234, 235 also allow adjacent vial seals within a corresponding receptacle row to be spaced apart in order to prevent or minimize contamination between the vial seals. For instance, the grip spaces 234, 235 provide sufficient clearance that allows a user to remove a single vial seal from an individual receptacle 220 in the vial seal tray by gripping opposing sides of the vial seal by way of the respective grip spaces without touching or contaminating other vial seals disposed in the vial seal tray, such as a vial seal disposed in an adjacent receptacle 220 in the shared receptacle row 230. Such a tray configuration makes it easier for a user working at a small work space, such as a biosafety cabinet, to remove the individual vial seals from the tray. Directly adjacent receptacles 220 in each receptacle row 230 are spaced apart by the shallow channel 232, whereas adjacent receptacles 220 in adjacent receptacle rows 230 are separated by the connection web 240.

The vial seal tray 200 may be formed from one or more rigid or semi-rigid polymeric materials, including, but not limited to, polyethylene, polycarbonate, polypropylene and/or a composite combination of materials chosen to maintain the integrity of the stored vial seals. Additionally, a material, such as gamma stable polypropylene, which is stable following exposure to gamma radiation sterilization processes, may be used to make the vial seal tray.

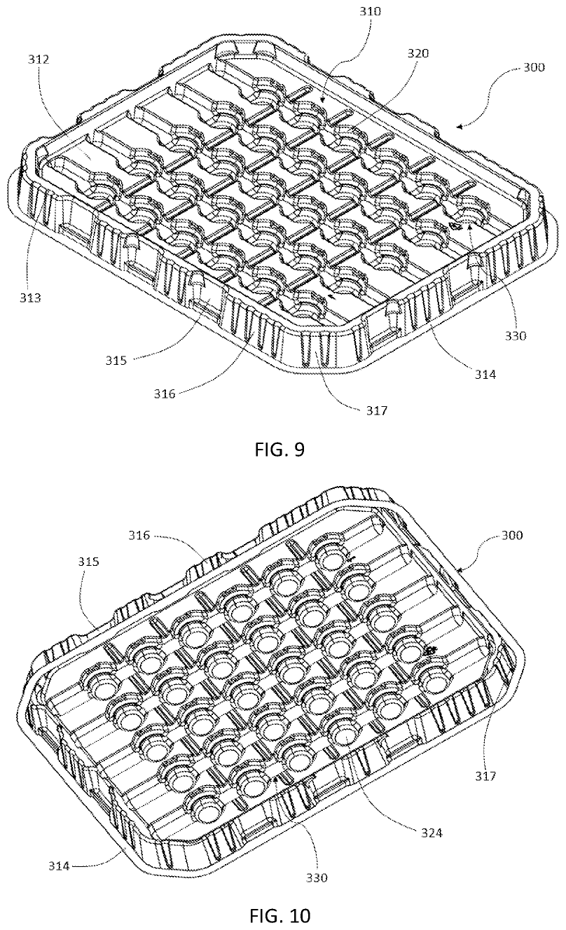

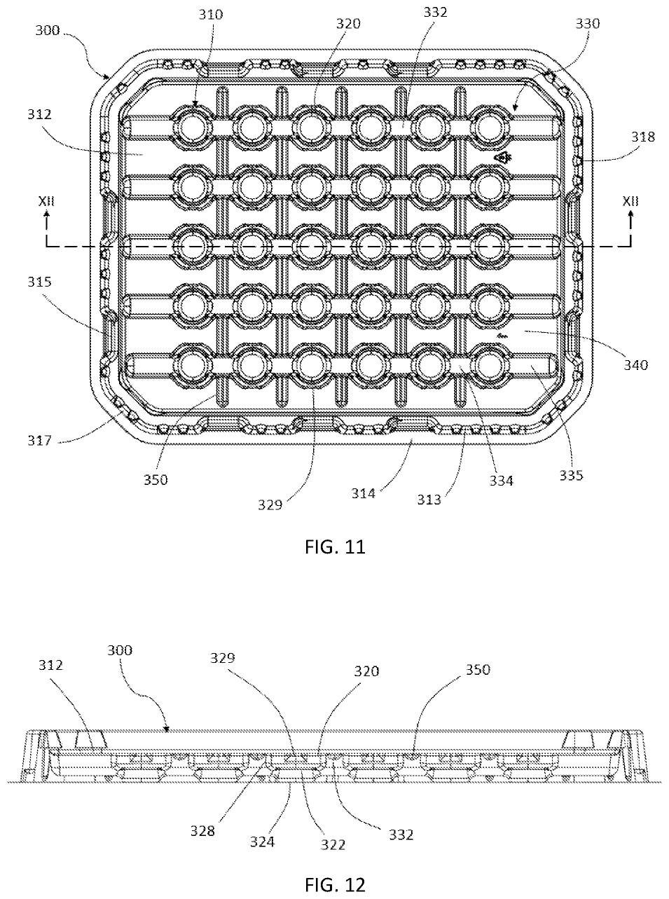

Turning to FIGS. 9-12, a vial stopper tray 300 according to the present disclosure is shown. The vial stopper tray 300 comprises a receptacle array 310 having a plurality of individual receptacles 320. Each individual receptacle is configured to releasably receive and secure a vial stopper. Similar to the aforementioned vial seal trays discussed above, the vial stopper tray 300 may be disposed within a container for protecting the vial stoppers from contamination. Such a container may include one or more sterile bags sized and shaped to accommodate the vial stopper tray. In some aspects, the sterile bag may be heat-sealed once the stopper tray is contained therein. Similar to the vial seal trays previously discussed above, the vial stopper tray 300 may be formed from one or more rigid or semi-rigid polymeric materials, including, but not limited to, polyethylene, polycarbonate, polypropylene and/or a composite combination of materials chosen to maintain the integrity of the stored vial seals.

The vial stopper tray 300 comprises a box-like body having a top surface 312 which is substantially rectangular in shape, and a base 314 defining a stabilization flange protruding outwardly along a perimeter of the stopper tray. A tray wall 316 extends between the top surface 312 and the base 314 along the perimeter of the stopper tray. The top surface 312 of the stopper tray may include a chamfered edge 313 along its perimeter to facilitate stacking with another vial stopper tray. The tray wall 316 may include one or more cutouts or notches 315 to similarly facilitate stacking with another vial stopper tray. In some implementations, the tray wall 316 may extend above the top surface 312, thus forming a cavity to further facilitate nesting of stacked stopper trays. Further, each corner 317 of the vial stopper tray 300 may be cut off to facilitate insertion of the tray into a primary bag during the packing process. Further, the corners may also help to facilitate stacking, as well as reduce the amount of raw material and associated costs required to manufacture the tray. Furthermore, the tray wall 316 may include one or more pleats 318 configured to increase stiffness of the wall in order to provide added stability to the tray.

The receptacle array 310 includes a plurality of spaced apart rectilinear receptacle rows 330. The plurality of receptacle rows 330 are interconnected by a connection web 340 formed on the top surface 312 of the vial stopper tray 300. Each receptacle row 330 includes a plurality of individually spaced apart receptacles 320. Further, each receptacle row 330 defines a shallow channel 332 connecting each of the plurality of individually spaced apart receptacles 320. Each receptacle 320 is configured to receive a portion of the vial stopper and may be substantially cylindrical in shape. The plurality of rectilinear receptacle rows 330 are arranged parallel to and spaced apart from each other, whereby the connection web 340 on the top surface 312 interconnects the receptacle rows 330.

The receptacle array 310 may include five spaced apart receptacle rows 330, with each of the receptacle rows having six receptacles 320. Each receptacle 320 may be sized and shaped to accommodate a 20 mm vial stopper. As such, the receptacle array 310 may be configured to releasably receive and secure up to thirty vial stoppers per tray. In other implementations, the receptacle array 310 may be configured to include more or less receptacle rows and associated receptacles. While the vial stopper tray is shown as a box-like rectangular tray, in other implementations it may be made into alternative configurations suitable for its intended use, such as where the outer perimeter of the tray has a shape of a square, a circle, or an oval, among various other shapes.

Each individual receptacle 320 includes a generally hollow cylindrical cavity 322 which extends downwardly from the connection web 340 at the top surface 312 of the tray to form a sidewall 328 bounded by a closed lower end 324. In some aspects, the cavity 322 may include a first or top portion and a second or bottom portion, where a diameter of the first or top portion is larger than a diameter of the second or bottom portion. As such, a vial stopper may be secured within the first or top portion while the second or bottom portion remains empty. In some implementations, a narrow central protrusion or region may extend upwardly from a central region of the closed lower end 324. The protrusion may include a tip portion configured to provide stiffness and stability to the cavity, as well as support a vial stopper when the vial stopper is received within the receptacle. The tip portion may have a hemispherical or dome shape, among other shapes. Additionally, each receptacle 320 includes a holding retention or bumper 329 protruding into the respective cavity 322. The bumper 329 is configured to releasably secure a portion of a corresponding vial stopper within the cavity 322.

Accordingly, each bumper 329 acts as a holding portion provided at an upper end of each respective receptacle. The bumper extends radially inwards into the cavity of the receptacle, thus forming a constricted opening or neck portion of the receptacle for securing the vial stopper. For instance, a vial stopper may be snapped into a respective receptacle by pushing the vial stopper until it engages the corresponding bumper of the receptacle. Further, each receptacle may include one or more bumpers 329. For instance, each receptacle may include two bumpers which are diametrically opposite to each other. The bumpers limit the axial mobility of the vial stoppers accommodated in the corresponding receptacles by a positive locking engagement which securely retains the vial stoppers in the receptacles in a generally vertical orientation, while also permitting the user to pull each individual vial stopper with a sufficient force to disengage the bumper and thus remove the stopper from its respective receptacle.

The shallow channel 332 connecting each receptacle 320 within a corresponding receptacle row 330 serves a dual function. Firstly, the channel 332 provides sufficient clearance or grip space to facilitate manual removal of each individual vial stopper from a corresponding receptacle of the stopper tray. Secondly, the channel 332 allows for steam sterilization of any vial stoppers disposed in the stopper tray.

In particular, channel 332 provides sufficient clearance or grip space 334 between each adjacent receptacle within the row, as well as sufficient clearance or grip space 335 at each end of the row next to a respective receptacle. For instance, the grip spaces 334, 335 allow a user to manually grasp opposing sides of a vial stopper disposed in a corresponding receptacle 320 in order to easily remove each individual vial stopper from the tray by using either the user's fingers or a gripping tool. Further, these grip spaces 334, 335 also allow adjacent vial stoppers within a corresponding receptacle row to be spaced apart in order to prevent or minimize contamination between the vial stoppers.

For instance, the grip spaces 334, 335 provide sufficient clearance that allows a user to remove a single vial stopper from an individual receptacle 320 in the vial stopper tray by gripping opposing sides of the vial stopper by way of the respective grip spaces without touching or contaminating other vial stoppers disposed in the vial stopper tray, such as a vial stopper disposed in an adjacent receptacle 320 in the shared receptacle row 330. Such a tray configuration makes it easier for a user working at a small work space, such as a biosafety cabinet, to remove the individual vial stoppers from the tray. Directly adjacent receptacles 320 in each receptacle row 330 are spaced apart by the shallow channel 332, whereas adjacent receptacles 320 in adjacent receptacle rows 330 are separated by the connection web 340.

Further, the shallow channels 332 permit steam sterilization of the individual vial stoppers disposed in the stopper tray. In particular, as sterilizing steam is introduced into each channel 332, the steam is allowed to flow into contact with each individual vial stopper (e.g., by flowing up and around the vial stopper) as the steam travels along the length of the respective channel. The empty second or bottom portion of the receptacle helps the steam sterilization flow along the channel and into contact with an underside of the vial stopper secured within the first or top portion of the receptacle. The vial stopper tray 300 also includes one or more reinforcement ribs 350 configured to provide stability to the tray. Each reinforcement rib 350 is disposed on the top surface of the 312 of the stopper tray and extends across the top surface substantially perpendicular to the receptacle rows 330. With this arrangement, each reinforcement rib 350 adds stiffness to the top surface of the tray to prevent undesirable flexing of the tray. For instance, the vial stopper tray 300 may include five reinforcement ribs 350, wherein each reinforcement rib is disposed between adjacent receptacles of a corresponding receptacle row, and furthermore, wherein each reinforcement rib perpendicularly extends across all five receptacle rows.

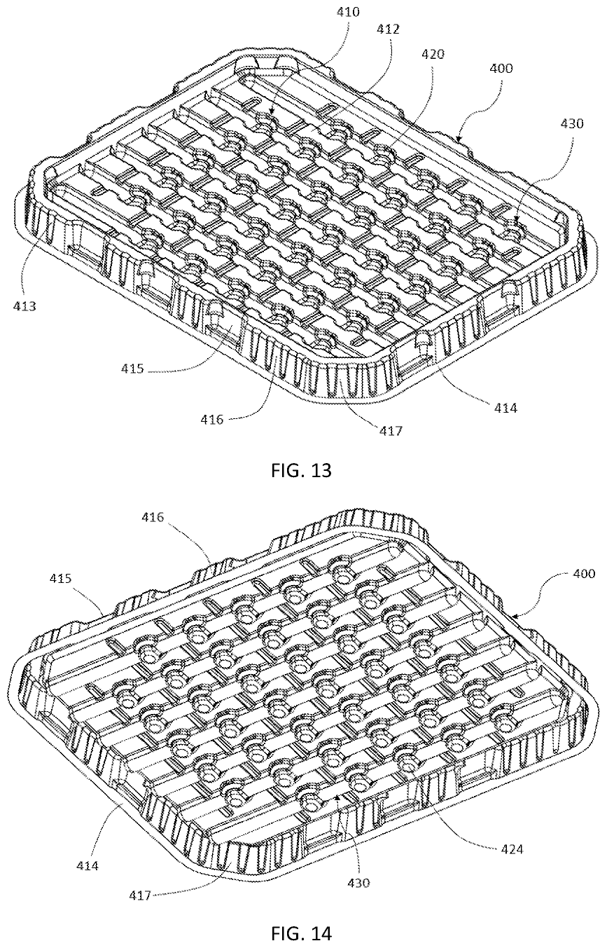

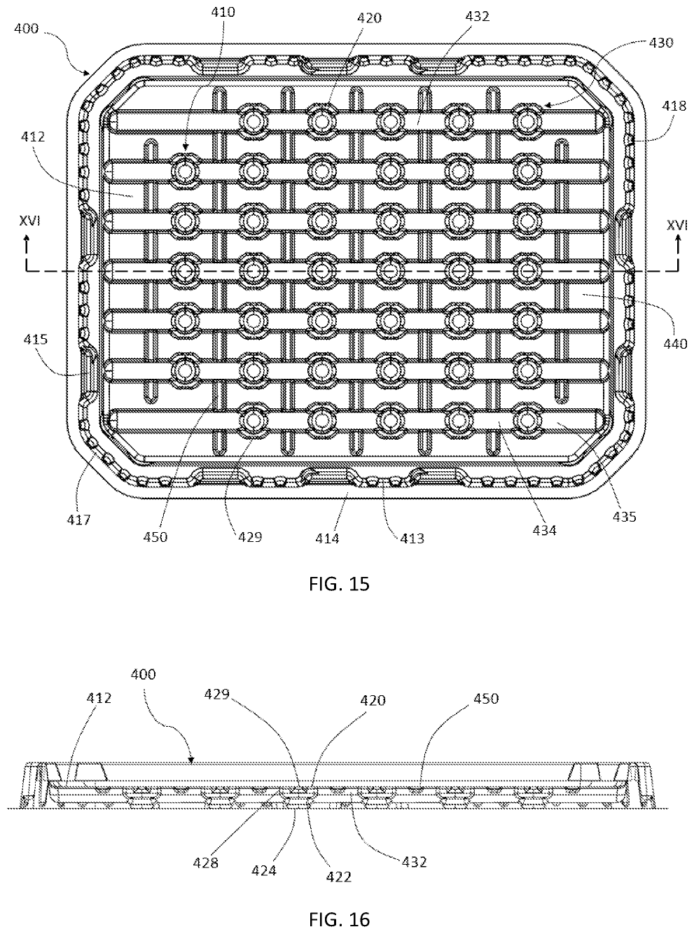

Referring to FIGS. 13-16, another implementation of a vial stopper tray 400 is shown. While vial stopper tray 400 shares various features of the vial stopper tray 300 previously discussed. More particularly, the vial stopper tray 400 comprises a receptacle array 410 having a plurality of individual receptacles 420. For instance, the vial stopper tray 400 may include a receptacle array 410 including seven spaced apart receptacle rows 430, with five of the receptacle rows having six receptacles 420 each, and the remaining two receptacle rows having five receptacles each. Each receptacle 420 may be sized and shaped to accommodate a 13 mm vial stopper. As such, the receptacle array 410 may be configured to releasably receive and secure up to forty vial stoppers per tray. In other implementations, the receptacle array 410 may be configured to include more or less receptacle rows and associated receptacles. Further, the vial stopper tray 400 may include a plurality of reinforcement ribs 450, such as seven reinforcement ribs, wherein each reinforcement rib is perpendicularly disposed on the top surface of the tray adjacent to, and spaced apart from, opposite sides of each receptacle of the respective receptacle rows.

Each individual receptacle 420 of the receptacle array 410 is configured to releasably receive and secure a vial stopper. The vial stopper tray 400 may be disposed within a container for protecting the vial stoppers from contamination. Such a container may include one or more sterile bags sized and shaped to accommodate the vial stopper tray. In some aspects, the sterile bag may be heat-sealed once the stopper tray is contained therein. The vial stopper tray 400 may be formed from one or more rigid or semi-rigid polymeric materials, including, but not limited to, polyethylene, polycarbonate, polypropylene and/or a composite combination of materials chosen to maintain the integrity of the stored vial stoppers.

The vial stopper tray 400 comprises a box-like body having a top surface 412 which is substantially rectangular in shape, and a base 414 defining a stabilization flange protruding outwardly along a perimeter of the stopper tray. A tray wall 416 extends between the top surface 412 and the base 414 along the perimeter of the stopper tray. The top surface 412 of the stopper tray may include a chamfered edge 413 along its perimeter to facilitate stacking with another vial stopper tray. The tray wall 416 may include one or more cutouts or notches 415 to similarly facilitate stacking with another vial stopper tray. In some implementations, the tray wall 416 may extend above the top surface 412, thus forming a cavity to further facilitate nesting of stacked stopper trays. Further, each corner 417 of the vial stopper tray 400 may be cut off to facilitate insertion of the tray into a primary bag during the packing process. Further, the corners may also help to facilitate stacking, as well as reduce the amount of raw material and associated costs required to manufacture the tray. Furthermore, the tray wall 416 may include one or more pleats 418 configured to increase stiffness of the wall in order to provide added stability to the tray.

The receptacle array 410 includes a plurality of spaced apart rectilinear receptacle rows 430. The plurality of receptacle rows 430 are interconnected by a connection web 440 formed on the top surface 412 of the vial stopper tray 400. Each receptacle row 430 includes a plurality of individually spaced apart receptacles 420. Further, each receptacle row 430 defines a shallow channel 432 connecting each of the plurality of individually spaced apart receptacles 420. Each receptacle 420 is configured to receive a portion of the vial stopper and may be substantially cylindrical in shape. The plurality of rectilinear receptacle rows 430 are arranged parallel to and spaced apart from each other, whereby the connection web 440 on the top surface 412 interconnects the receptacle rows 430.

Each individual receptacle 420 includes a generally hollow cylindrical cavity 422 which extends downwardly from the connection web 440 at the top surface 412 of the tray to form a sidewall 428 bounded by a closed lower end 424. In some aspects, the cavity 422 may include a first or top portion and a second or bottom portion, where a diameter of the first or top portion is larger than a diameter of the second or bottom portion. In some aspects, a narrow central protrusion or region may extend upwardly from a central region of the closed lower end 424. The protrusion may include a tip portion configured to provide stiffness and stability to the tray, as well as support a vial stopper when the vial stopper is received within the receptacle. The tip portion may have a hemispherical or dome shape, among other shapes. Additionally, each receptacle 420 includes a holding retention or bumper 429 protruding into the respective cavity 422. The bumper 429 is configured to releasably secure a portion of a corresponding vial stopper within the cavity 422.

Each bumper 429 acts as a holding portion provided at an upper end of each respective receptacle. The bumper extends radially inwards into the cavity of the receptacle, thus forming a constricted opening or neck portion of the receptacle for securing the vial stopper. For instance, a vial stopper may be snapped into a respective receptacle by pushing the vial stopper until it engages the corresponding bumper of the receptacle. Further, each receptacle may include one or more bumpers 429. For instance, each receptacle may include two bumpers which are diametrically opposite to each other. The bumpers limit the axial mobility of the vial stoppers accommodated in the corresponding receptacles by a positive locking engagement which securely retains the vial stoppers in the receptacles in a generally vertical orientation, while also permitting the user to pull each individual vial stopper with a sufficient force to disengage the bumper and thus remove the stopper from its respective receptacle.

The shallow channel 432 connecting each receptacle 420 within a corresponding receptacle row 430 serves a dual function. Firstly, the channel 432 provides sufficient clearance or grip space to facilitate manual removal of each individual vial stopper from a corresponding receptacle of the stopper tray. Secondly, the channel 432 allows for steam sterilization of any vial stoppers disposed in the stopper tray.

In particular, channel 432 provides sufficient clearance or grip space 434 between each adjacent receptacle within the row, as well as sufficient clearance or grip space 435 at each end of the row next to a respective receptacle. For instance, the grip spaces 434, 435 allow a user to manually grasp opposing sides of a vial stopper disposed in a corresponding receptacle 420 in order to easily remove each individual vial stopper from the tray by using either the user's fingers or a gripping tool. Further, these grip spaces 434, 435 also allow adjacent vial stoppers within a corresponding receptacle row to be spaced apart in order to prevent or minimize contamination between the vial stoppers.

For instance, the grip spaces 434, 435 provide sufficient clearance that allows a user to remove a single vial stopper from an individual receptacle 420 in the vial stopper tray by gripping opposing sides of the vial stopper by way of the respective grip spaces without touching or contaminating other vial stoppers disposed in the vial stopper tray, such as a vial stopper disposed in an adjacent receptacle 420 in the shared receptacle row 430. Such a tray configuration makes it easier for a user working at a small work space, such as a biosafety cabinet, to remove the individual vial stoppers from the tray. Directly adjacent receptacles 420 in each receptacle row 430 are spaced apart by the shallow channel 432, whereas adjacent receptacles 420 in adjacent receptacle rows 430 are separated by the connection web 440.

Further, the shallow channels 432 permit steam sterilization of the individual vial stoppers disposed in the stopper tray. In particular, as sterilizing steam is introduced into each channel 432, the steam is allowed to flow into contact with each individual vial stopper (e.g., by flowing up and around the vial stopper) as the steam travels along the length of the respective channel. The vial stopper tray 400 also includes one or more reinforcement ribs 450 configured to provide stability to the tray. Each reinforcement rib 450 is disposed on the top surface of the 412 of the stopper tray and extends across the top surface substantially perpendicular to the receptacle rows 430. With this arrangement, each reinforcement rib 450 adds stiffness to the top surface of the tray to prevent undesirable flexing of the tray. For instance, the vial stopper tray 400 may include five reinforcement ribs 450, wherein each reinforcement rib is disposed between adjacent receptacles of a corresponding receptacle row, and furthermore, wherein each reinforcement rib perpendicularly extends across all five receptacle rows.

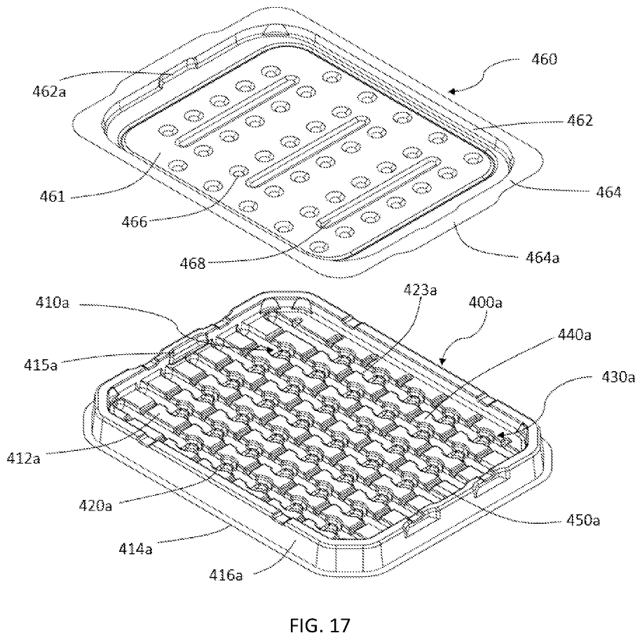

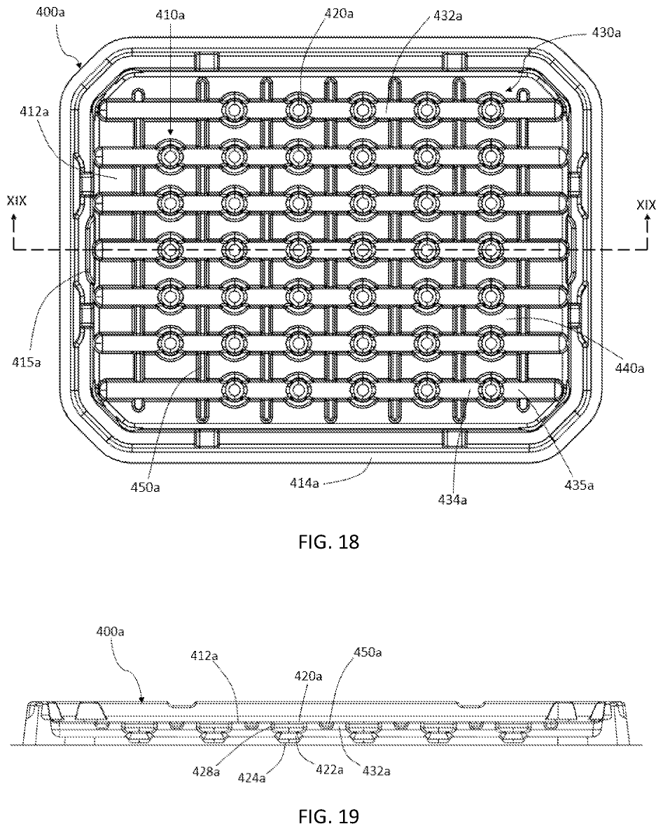

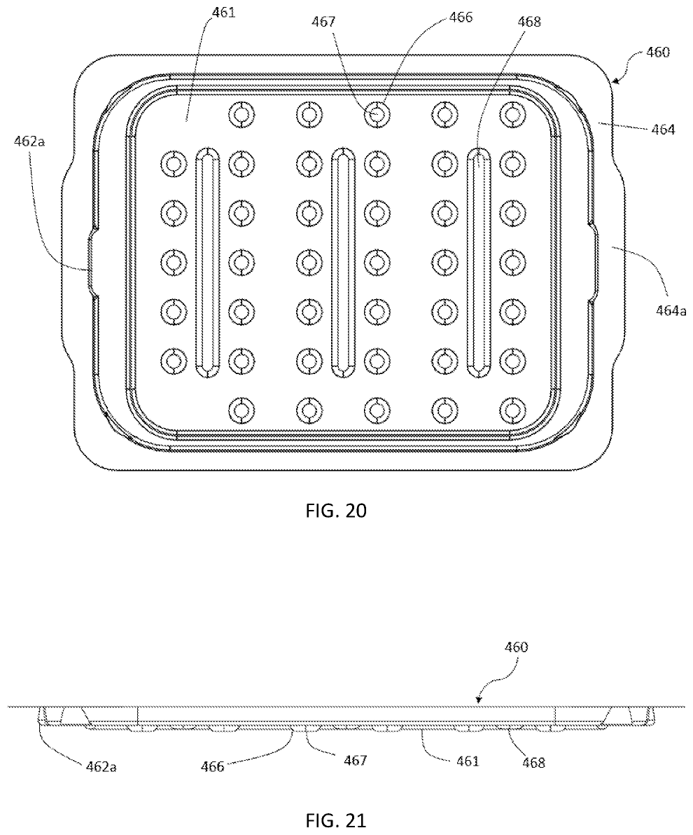

Referring to FIGS. 17-21, another implementation of a vial stopper tray 400a is shown, which shares various features of the vial stopper tray 400 previously discussed. A stopper tray lid or cover 460 is configured to removably attach to the vial stopper tray 400a to both secure and protect the vial stoppers disposed in the vial stopper tray 400a. The vial stopper tray 400a comprises a receptacle array 410a having a plurality of individual receptacles 420a. For instance, the vial stopper tray 400a may include a receptacle array 410a including seven spaced apart receptacle rows 430a, with five of the receptacle rows having six receptacles each, and the remaining two receptacle rows having five receptacles each. Each receptacle 420a may be sized and shaped to accommodate a 13 mm vial stopper. As such, the receptacle array 410a may be configured to releasably receive and secure up to forty vial stoppers per tray. In other implementations, the receptacle array 410a may be configured to include more or less receptacle rows and associated receptacles. Further, the vial stopper tray 400a may include a plurality of reinforcement ribs 450a, such as seven reinforcement ribs, wherein each reinforcement rib is perpendicularly disposed on the top surface of the tray adjacent to, and spaced apart from, opposite sides of each receptacle of the respective receptacle rows.

Each individual receptacle 420a of the receptacle array 410a is configured to releasably receive a respective vial stopper. The vial stopper tray 400a comprises a box-like body having a top surface 412a which is substantially rectangular in shape, and a base 414a defining a stabilization flange protruding outwardly along a perimeter of the stopper tray. A tray wall 416a extends between the top surface 412a and the base 414a along the perimeter of the vial stopper tray. One or more cutouts or notches 415a may be provided on an interior side of the tray wall 416a for receiving a corresponding protrusion 462a of the lid 460. In some implementations, the tray wall 416a may extend above the top surface 412a, thus forming a cavity to facilitate nesting of the lid 460 on top of the vial stopper tray.

The receptacle array 410a includes a plurality of spaced apart rectilinear receptacle rows 430a. The plurality of receptacle rows 430a are interconnected by a connection web 440a formed on the top surface 412a of the vial stopper tray 400a. Each receptacle row 430a includes a plurality of individually spaced apart receptacles 420a. Further, each receptacle row 430a defines a shallow channel 432a connecting each of the plurality of individually spaced apart receptacles 420a. Each receptacle 420a is configured to receive a portion of the vial stopper and may be substantially cylindrical in shape. The plurality of rectilinear receptacle rows 430a are arranged parallel to and spaced apart from each other, whereby the connection web 440a on the top surface 412a interconnects the plurality of receptacle rows 430a.

Each individual receptacle 420a includes a generally hollow cylindrical cavity 422a which extends downwardly from the connection web 440a at the top surface 412a of the tray to form a sidewall 428a bounded by a closed lower end 424a. In some aspects, the cavity 422a may include a first or top portion and a second or bottom portion, where a diameter of the first or top portion is larger than a diameter of the second or bottom portion. As such, a vial stopper may be secured within the first or top portion while the second or bottom portion remains empty.

The shallow channel 432a connecting each receptacle 420a within a corresponding receptacle row 430a serves a dual function. Firstly, the channel 432a provides sufficient clearance or grip space to facilitate manual removal of each individual vial stopper from a corresponding receptacle of the stopper tray. Secondly, the channel 432a allows for steam sterilization of any vial stoppers disposed in the stopper tray.

In particular, channel 432a provides sufficient clearance or grip space 434a between each adjacent receptacle within the row, as well as sufficient clearance or grip space 435a at each end of the row next to a respective receptacle. For instance, the grip spaces 434a, 435a allow a user to manually grasp opposing sides of a vial stopper disposed in a corresponding receptacle 420a in order to easily remove each individual vial stopper from the tray by using either the user's fingers or a gripping tool. Further, these grip spaces 434a, 435a also allow adjacent vial stoppers within a corresponding receptacle row to be spaced apart in order to prevent or minimize contamination between the vial stoppers.

For instance, the grip spaces 434a, 435a provide sufficient clearance that allows a user to remove a single vial stopper from an individual receptacle 420a in the vial stopper tray by gripping opposing sides of the vial stopper by way of the respective grip spaces without touching or contaminating other vial stoppers disposed in the vial stopper tray, such as a vial stopper disposed in an adjacent receptacle 420a in the shared receptacle row 430a. Such a tray configuration makes it easier for a user working at a small work space, such as a biosafety cabinet, to remove the individual vial stoppers from the tray. Directly adjacent receptacles 420a in each receptacle row 430a are spaced apart by the shallow channel 432a, whereas adjacent receptacles 420a in adjacent receptacle rows 430a are separated by the connection web 440a. Further, the shallow channels 432a permit steam sterilization of the individual vial stoppers disposed in the stopper tray. In particular, as sterilizing steam is introduced into each channel 432a, the steam is allowed to flow into contact with each individual vial stopper (e.g., by flowing up and around the vial stopper) as the steam travels along the length of the respective channel. The empty second or bottom portion of the receptacle helps the steam sterilization flow along the channel and into contact with an underside of the vial stopper secured within the first or top portion of the receptacle

The vial stopper tray 400a also includes one or more reinforcement ribs 450a configured to provide stability to the tray. Each reinforcement rib 450a is disposed on the top surface of the 412a of the stopper tray and extends across the top surface substantially perpendicular to the receptacle rows 430a. With this arrangement, each reinforcement rib 450a adds stiffness to the top surface of the tray to prevent undesirable flexing of the tray. For instance, the vial stopper tray 400a may include five reinforcement ribs 450a, wherein each reinforcement rib is disposed between adjacent receptacles of a corresponding receptacle row. Each reinforcement rib 450a may also perpendicularly extend across all five receptacle rows.

The stopper tray lid 460 is configured to removably attach to the vial stopper tray 400a for both securing and protecting the vial stoppers disposed in the respective receptacles 420a of the stopper tray. The stopper tray lid 460 includes a lid base 461 having a side wall 462 extending along a perimeter of the lid base. One or more of the locking protrusions 462a extend from a portion of the side wall 462 for matingly engaging a respective cutout or notch 415a provided on the interior side of the tray side wall 416a for releasably securing the stopper tray lid to the stopper tray. For instance, an interference fit may be formed between the locking protrusion 462a and the cutout 415a. A lid flange 464 protrudes outwardly from the sidewall 462 along the perimeter of the tray lid. The lid flange 464 may include an enlarged grip portion 464a to assist a user with detaching the stopper tray lid from the stopper tray.

A bottom surface of the lid base 461 includes a plurality of retention regions 466 protruding therefrom, with each retention region corresponding to a respective receptacle 420a of the stopper tray 400a. Each retention region 466 is sized and shaped to fit within a corresponding receptacle 420a when the stopper tray lid is attached to the stopper tray. Further, each retention region 466 includes a tip portion 467 configured to hold a vial stopper in place within a corresponding receptacle 420a of the stopper tray when the stopper tray lid is attached to the stopper tray. Each tip portion 467 may be substantially flat so as to maximize surface area contact with a respective vial stopper.

One or more lid reinforcement ribs 468 may be provided on the lid base 461 for providing stability to the tray lid. Each lid reinforcement rib 468 may protrude from the bottom surface of the lid base. Additionally, each lid reinforcement rib 468 may extend across the lid base in a direction substantially perpendicular to the receptacle rows 430a. For instance, the lid reinforcement ribs 468 may extend in the same direction as the reinforcement ribs 450a of the stopper tray. With this arrangement, each lid reinforcement rib 468 adds stiffness to the lid base to prevent undesirable flexing thereof. In some implementations, for instance, the tray lid may include a number of lid reinforcement ribs 468 corresponding to the number of reinforcement ribs 450a of the stopper tray.

After the tray lid 460 is attached to the vial stopper tray 400a, they may be stored within a container, such a sterile bag. In some aspects, the sterile bag may be heat-sealed once the stopper tray assembly is contained therein. Additionally, the vial stopper tray 400 and the tray lid 460 may both be formed from one or more rigid or semi-rigid polymeric materials, including, but not limited to, polyethylene, polycarbonate, polypropylene and/or a composite combination of materials chosen to maintain the integrity of the stored vial stoppers.

In further implementations, a kit may be provided which includes various combinations of the aforementioned vial seal trays and vial stopper trays, as well as a vial tray containing a corresponding number of pharmaceutical vials. For instance, such a collection of trays may form a small quantity kit suitable for bio-fillings or the like. Thus, such a kit allows a user to easily access individual vial seals and vial stoppers from their respective trays while working at a small work space, such as a biosafety cabinet or a laboratory desk with hood. Such a kit arrangement makes it much easier for the user to assemble the seals and stoppers on a corresponding vial when compared to conventional seal and/or stopper packaging methods. Moreover, such a kit advantageously eliminates or minimizes the risk of contamination of the component vial seals and vial stoppers since a user can individually remove each unit from its respective tray. In particular, the various vial seal trays, vial stopper trays, and vial trays permit the respective seals, stoppers and vials to be presented in a space-saving rack-like structure to a biosafety cabinet operator in an efficient orientation for use (i.e., by facilitating grasping, carrying and placing each seal and stopper onto a corresponding vial). For example, the vial seals may be oriented with their plastic button facing up, and the vial stoppers may be oriented with their top flange facing up. In contrast, vial closures dumped onto a work surface from a conventional bulk pack would not be presented in the right orientation since some would land upside down or on their side.

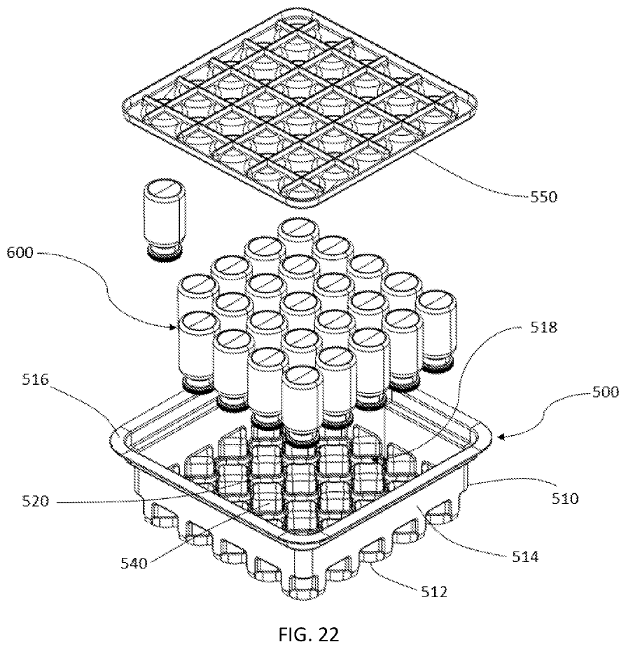

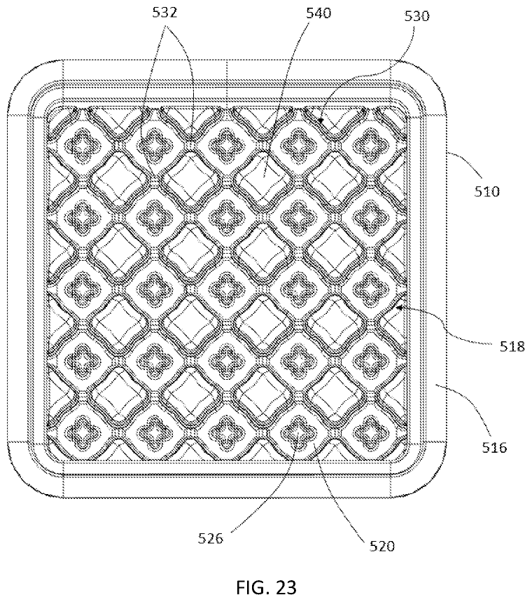

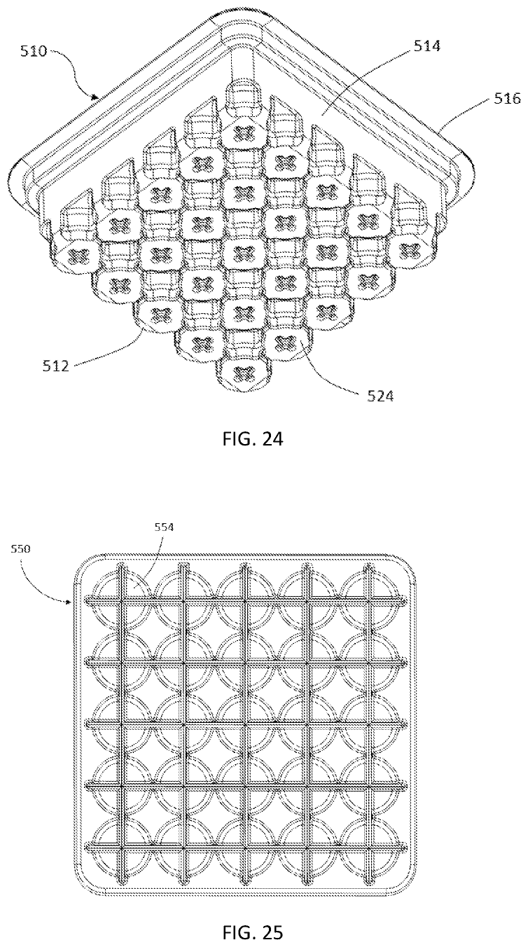

FIGS. 22-25 show an implementation of a vial tray assembly 500 that comprises a base 510 defining a general box-like shape having a bottom wall 512 and a sidewall 514 extending along a periphery of the base. An upper surface of the sidewall 514 is in the form of a generally planar flange 516 extending laterally outward from the side wall. The bottom wall 512 defines a vial holder array 518 including a plurality of receptacles 520. Each receptacle 520 is configured to securely and releasably receive an individual vial so that a plurality of vials 600 are able to be held in the spaced array. The vial holder array 518 includes a plurality of spaced apart rectilinear receptacle rows 530 that are interconnected by a connection web 540. Each receptacle row 530 includes a plurality of individually spaced apart receptacles 520. Further, each receptacle row 530 defines a channel 532 connecting each of the plurality of individually spaced apart receptacles 520.

Each receptacle 520 is configured to receive a top portion of a corresponding vial. Stated another way, the vials are inserted upside down into the corresponding receptacles. In one implementation, the vial holder array 518 may include five spaced apart receptacle rows 530, with each receptacle row having five spaced-apart receptacles 520. Each receptacle 520 may be sized and shaped to accommodate a correspondingly sized and shaped vial. As such, the vial holder array 518 may be configured to releasably receive and secure up to twenty five vials per tray. In other implementations, the vial holder array 518 may be configured to include more or less receptacle rows and associated receptacles. While the vial tray is shown as a box-like square tray, in other implementations it may be made into alternative configurations suitable for its intended use, such as where the outer perimeter of the tray has a shape of a rectangle, a circle, or an oval, among various other shapes.

Each individual receptacle 520 includes a generally hollow cavity 522 defined by the connection web 540 to form a closed lower end 524. A centrally located protrusion or region 526 forming a center post extends upwardly from a central region of the closed lower end 524. The region 526 is configured to support the vial when the vial is received within the receptacle 520 in a generally vertical orientation. The region 526 may be generally cross-shaped, among other shapes. Each receptacle has a cross-section configured to securely and releasably hold an individual vial. In some implementations, this may be accomplished via a clearance fit, wherein each center post aids in controlling the respective vial's position. The channel 532 connecting each receptacle 520 within a corresponding receptacle row 530 provides sufficient clearance between each adjacent receptacle within the row. In other implementations, the vials may be secured via an interference fit. In further implementations, the center post may be omitted.

Additionally, the vial tray assembly 500 may also comprise a vial tray lid or cover 550 that includes a plurality of downward facing recesses 554 spaced from one another by the same spacing as the vials in the vial holder array 518. Since the vials are inverted within each corresponding receptacle 520 of the vial tray, each recess 554 of the lid is arranged to hold a bottom portion of a respective vial. An outer periphery of the vial tray lid 550 is shaped and dimensioned to fit within an open portion of the base 510 in order to close the base and accordingly seal the vials therein.

Similar to the vial seal trays and the vial stopper trays previously described, the vial tray assembly 500 may be formed from one or more rigid or semi-rigid polymeric materials, including, but not limited to, polyethylene, polycarbonate, polypropylene and/or a composite combination of materials chosen to maintain the integrity of the stored vials. Additionally, a material, such as gamma stable polypropylene, which is stable following exposure to gamma radiation sterilization processes, may be used to make the vial tray.

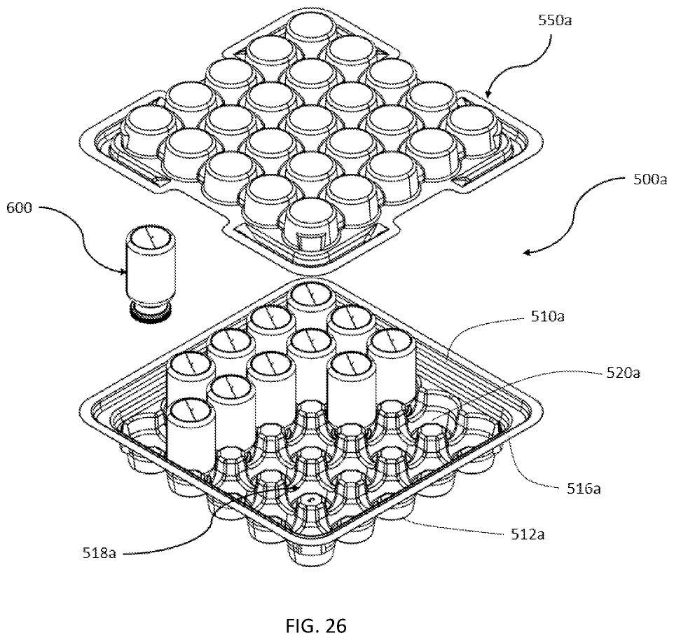

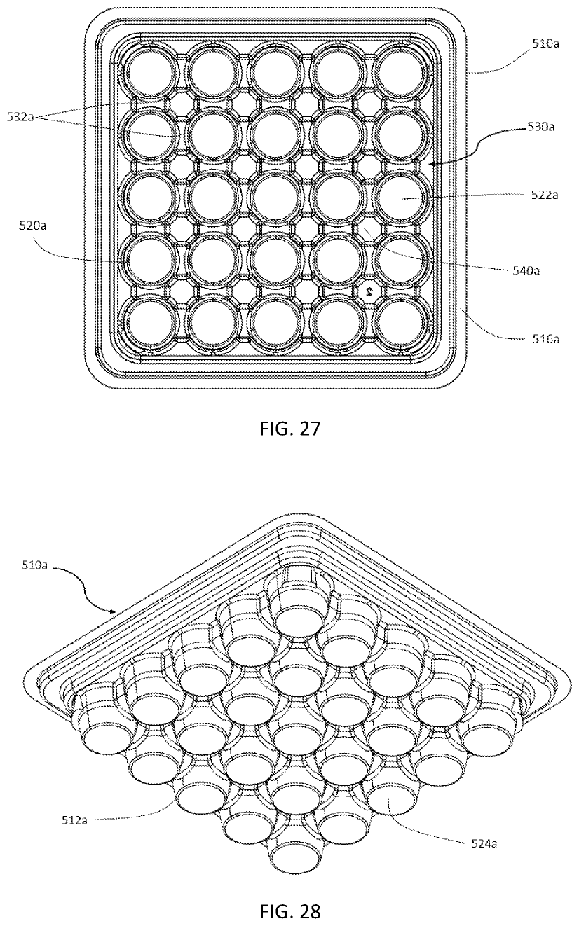

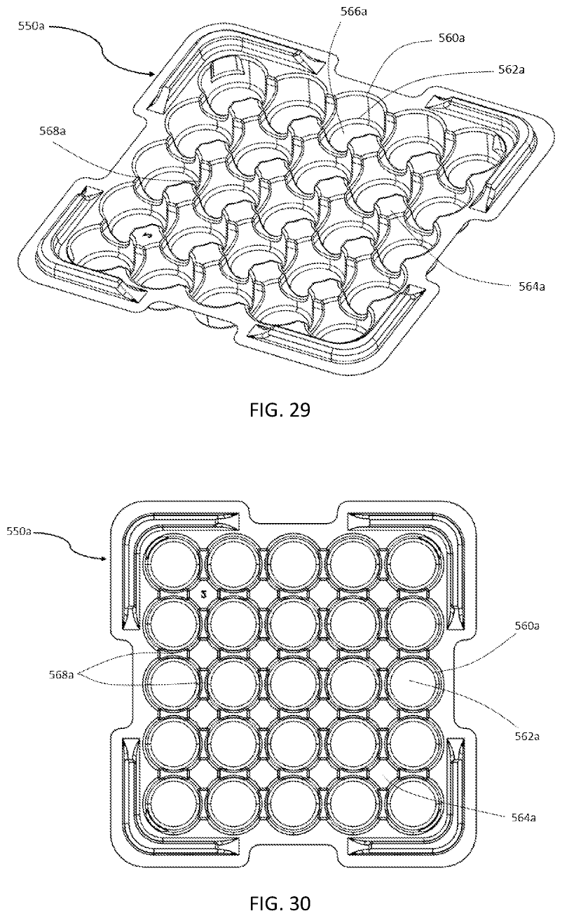

FIGS. 26-30 show another implementation of a vial tray assembly 500a that comprises a base tray 510a having a generally planar flange 516a extending laterally outward along a periphery of the base tray. A bottom portion 512a defines a vial holder array 518a including a plurality of receptacles 520a. Each receptacle 520a is configured to securely and releasably receive an individual vial so that a plurality of vials 600 are able to be held in the spaced array. The vial holder array 518a includes a plurality of spaced apart rectilinear receptacle rows 530a that are interconnected by a connection web 540a. Each receptacle row 530a includes a plurality of individually spaced apart receptacles 520a. Further, each receptacle row 530a defines a channel 532a connecting each of the plurality of individually spaced apart receptacles 520a.

Each receptacle 520a is configured to receive a top portion of a corresponding vial. As such, the vials are inserted upside down into the corresponding receptacles 520a. In one implementation, the vial holder array 518a may include five spaced apart receptacle rows 530a, with each receptacle row having five spaced-apart receptacles 520a. Each receptacle 520a may be sized and shaped to accommodate a correspondingly sized and shaped vial. Thus, the vial holder array 518a may be configured to releasably receive and secure up to twenty five vials per tray. In other implementations, the vial holder array 518a may be configured to include more or less receptacle rows and associated receptacles.

Each individual receptacle 520a includes a generally hollow cavity 522a defined by the connection web 540a to form a closed lower end 524a. A bottom surface of the cavity 522a may be planar to ensure a sufficient contact area with the top portion of the vial. In some implementations, each receptacle may be configured to securely and releasably hold an individual vial via an interference fit. The channel 532a connecting each receptacle 520a within a corresponding receptacle row 530a provides sufficient clearance between each adjacent receptacle within the row.

Additionally, the vial tray assembly 500a may also comprise a vial tray lid or cover 550a that is configured to releasably attach to the base tray 510a, such as via a snap fit in some implementations. In other implementations, a vacuum bag may hold the tray and lid together, wherein the relative position of the tray and lid are controlled in the lateral directions (i.e., the x & y directions; where the z direction has no interference since it is a free release) by a segmented wall extending around an edge of the lid. This segmented wall is broken in the middle of each edge by a cut out portion. The vial tray lid 550a further includes a plurality of lid receptacles 560a that correspond to the respective receptacles 520a of the base tray 510a. Each lid receptacle 560a includes a generally hollow cavity 562a defined by a connection web 564a and forms a closed upper end 566a having a planar surface that ensures a sufficient contact area with the bottom portion of the vial. In some implementations, each lid receptacle may be configured to securely and releasably hold an individual vial via an interference fit. A channel 568a connecting each lid receptacle 560a provides sufficient clearance between each adjacent receptacle within the row. Accordingly, when a top portion of a vial is placed into a receptacle 520a of the base tray 510a, the tray lid 550a can be attached to the base tray 510a in such a manner that a bottom portion of the vial is received within a corresponding receptacle 560a of the tray lid. The closed upper end 566a of the tray lid contacts the bottom portion of the respective vial to secure it in place. As a result, the vial tray assembly, when closed, is able to present the vials in different orientations, such as a vial oriented with its top portion facing upward, or its top portion facing downward. This also allows the vial tray or vial tray lid to be removed without contacting each other.

While certain implementations of a vial seal tray, a vial stopper tray, a vial tray, and an associated kit have been described in terms of what may be considered to be specific aspects, the present disclosure is not limited to the disclosed aspects. Additional modifications and improvements to the aforementioned trays and kits may be apparent to those skilled in the art. Moreover, the many features and advantages of the disclosure are apparent from the detailed specification, and thus, it is intended by the appended claims to cover all such features and advantages of the present disclosure which fall within the spirit and scope of the disclosure.

1. A vial seal tray comprising:
a body having a top surface defining a receptacle array, the receptacle array comprising a plurality of receptacle rows, each of the plurality of receptacle rows comprising a plurality of individual spaced-apart receptacles configured to releasably secure a respective vial seal;
a connection web disposed on the top surface of the vial seal tray and interconnecting the plurality of individual receptacles, each receptacle defining a hollow cavity extending downwardly from the top surface of the vial seal tray and forming a closed lower end, the hollow cavity configured to receive a portion of the vial seal;
a region protruding upwardly from a central portion of the closed lower end of each receptacle for supporting the vial seal; and
a channel extending through the plurality of individually spaced-apart receptacles disposed in each respective receptacle row, the channel forming a clearance on opposing sides of each receptacle for facilitating grasping of the vial seal held in the corresponding receptacle.

2. The vial seal tray according to claim 1, wherein the plurality of receptacle rows are arranged parallel to each other and laterally offset from one another, such that each receptacle in adjacent receptacle rows is correspondingly offset from one another.

3. (canceled)

4. The vial seal tray according to claim 1, wherein the vial seal tray includes a base defining a flange protruding outwardly along a periphery of the vial seal tray.

5. The vial seal tray according to claim 4, further including a tray wall extending between the top surface and the base along the periphery of the vial seal tray.

6. (canceled)

7. The vial seal tray according to claim 1, wherein the top surface of the vial seal tray includes a chamfered edge along its perimeter.

8. (canceled)

9. A vial stopper tray comprising:
a body having a top surface defining a receptacle array, the receptacle array comprising a plurality of receptacle rows, each of the plurality of receptacle rows comprising a plurality of individual spaced-apart receptacles configured to releasably secure a respective vial stopper;
a connection web disposed on the top surface of the vial stopper tray and interconnecting the plurality of individual receptacles, each receptacle defining a hollow cavity extending downwardly from the top surface of the vial stopper tray and forming a closed lower end, the hollow cavity configured to receive a portion of the vial stopper;
a region protruding upwardly from a central portion of the closed lower end of each receptacle for supporting the vial stopper; and
a channel extending through the plurality of individually spaced-apart receptacles disposed in each respective receptacle row, the channel forming a clearance on opposing sides of each receptacle for facilitating grasping of the vial stopper held in the corresponding receptacle.

10. The vial stopper tray according to claim 9, wherein each receptacle includes a bumper configured to releasably secure a portion of a corresponding vial stopper within the cavity.

11. The vial stopper tray according to claim 10, wherein the bumper extends radially inward from an inner wall of the receptacle, the bumper forming a constricted opening of the cavity.

12. (canceled)

13. The vial stopper tray according to claim 9, wherein the channel is further configured to permit steam to flow along the receptacle row for sterilizing each vial stopper disposed in the receptacle row.

14. The vial stopper tray according to claim 9, further comprising a reinforcement rib disposed on the top surface of the vial stopper tray and extending perpendicularly to the channel for increasing stiffness of the top surface of the vial stopper tray.

15. (canceled)

16. The vial stopper tray according to claim 9, wherein the vial stopper tray includes a base defining a flange protruding outwardly along a periphery of the vial stopper tray.

17. The vial stopper tray according to claim 16, further including a tray wall extending between the top surface and the base along the periphery of the vial stopper tray.

18-19. (canceled)

20. The vial stopper tray according to claim 9, wherein the vial stopper tray includes a chamfered edge along its perimeter.

21. (canceled)

22. The vial stopper tray according to claim 9, further comprising a stopper tray lid configured to removably attach to the body of the vial stopper tray.

23. (canceled)

24. The vial stopper tray according to claim 22, wherein the stopper tray lid includes a lid base having a side wall extending along a perimeter of the lid base, and a locking protrusion extending from a portion of the side wall for matingly engaging a portion of the body of the vial stopper tray.

25. (canceled)

26. The vial stopper tray according to claim 22, wherein the stopper tray lid includes a bottom surface having a plurality of retention regions protruding therefrom, wherein each retention region is sized and shaped to fit within a corresponding receptacle of the vial stopper tray when the stopper tray lid is attached to the stopper tray.

27. (canceled)

28. A kit comprising: a vial tray comprising:
a tray base having a vial receptacle array, the vial receptacle array comprising a plurality of vial receptacle rows, each of the plurality of vial receptacle rows comprising a plurality of individual spaced-apart vial receptacles configured to receive a top portion of a respective vial; and
a vial seal tray comprising:
a seal tray body having a top surface defining a seal receptacle array, the seal receptacle array comprising a plurality of seal receptacle rows, each of the plurality of seal receptacle rows comprising a plurality of individual spaced-apart seal receptacles configured to receive a respective vial seal, and
a seal channel extending through the plurality of individually spaced-apart seal receptacles disposed in each respective seal receptacle row, the seal channel forming a clearance on opposing sides of each seal receptacle for facilitating grasping of the vial seal held in the corresponding receptacle; and
a vial stopper tray comprising:
a stopper tray body having a top surface defining a stopper receptacle array, the stopper receptacle array comprising a plurality of stopper receptacle rows, each of the plurality of stopper receptacle rows comprising a plurality of individual spaced-apart stopper receptacles configured to receive a respective vial stopper, and
a stopper channel extending through the plurality of individually spaced-apart stopper receptacles disposed in each respective stopper receptacle row, the stopper channel forming a clearance on opposing sides of each stopper receptacle for facilitating grasping of the vial stopper held in the corresponding receptacle.

29. The kit according to claim 28, wherein the vial tray further comprises a vial tray lid including a plurality of recesses arranged to receive a bottom portion of a respective vial.

30. The kit according to claim 29, wherein an outer periphery of the vial tray lid is shaped and dimensioned to fit within an open portion of the tray base for sealing each vial within the vial tray.

31. (canceled)

32. The kit according to claim 28, further comprising a primary container configured to receive the vial seal tray.

33. (canceled)

34. The kit according to claim 32, further comprising a secondary container configured to receive the vial seal tray and the primary container.

35. (canceled)
